(19) United States
(12) Patent Application Publication
(10) Pub. No.: US 2026/0070933 A1
(43) Pub. Date: Mar. 12, 2026

(54) GAS PHASE DEHYDROGENATIVE SILYLATION PROCESS USING A HETEROGENEOUS RHENIUM CATALYST

(71) Applicants: Dow Global Technologies LLC, Midland, MI (US); Dow Silicones Corporation, Midland, MI (US)

(72) Inventors: Ronen Weingarten, Be'er-Sheva (IL); Juan Venegas, Midland, MI (US); Krishna Janmanchi, Midland, MI (US); Aayush Singh, Midland, MI (US); Dimitris Katsoulis, Midland, MI (US); David Laitar, Midland, MI (US)

(21) Appl. No.: 19/101,751

(22) PCT Filed: Oct. 12, 2023
(86) PCT No.: PCT/US23/76638

§ 371 Date: Feb. 6, 2025

Related U.S. Application Data
(60) Provisional application No. 63/416,956, filed on Oct. 18, 2022.

(51) Int. Cl. C07F 7/14; B01J 21/04; B01J 21/18; B01J 23/36; B01J 37/16

(52) U.S. Cl. CPC C07F 7/14; B01J 21/04; B01J 21/18; B01J 23/36; B01J 37/16

(57) ABSTRACT

A process for preparing a vinyl-functional chlorosilane is performed by dehydrogenative silylation of a hydridochlorosilane and ethylene, both in the gas phase, in the presence of the heterogeneous rhenium catalyst. The process can be used to prepare vinyldimethylchlorosilane at ambient pressure.

### CROSS REFERENCE TO RELATED APPLICATIONS

This application claims the benefit of U.S. Provisional Patent Application No. 63/416,956 filed 18 Oct. 2022 under 35 U.S.C. § 119 (e). U.S. Provisional Patent Application No. 63/416,956 is hereby incorporated by reference.

### TECHNICAL FIELD

A process for preparing a vinyl-functional chlorosilane includes the use of a rhenium catalyst. More particularly, the process is performed by dehydrogenative silylation of a hydridochlorosilane and ethylene, both in the gas phase, in the presence of a heterogeneous rhenium catalyst.

### INTRODUCTION

Hydrosilylation reactions are generally known in the art and involve an addition reaction between silicon-bonded hydrogen and aliphatic unsaturation. Hydrosilylation reactions are utilized in various applications, such as for crosslinking components of curable compositions. Hydrosilylation reaction may also be utilized to prepare individual components or compounds, e.g., components for inclusion in such curable compositions. Typically, hydrosilylation reactions are carried out in the presence of a platinum-metal based catalyst due to its excellent catalytic activity and stability. While platinum metal is generally much more expensive than other metals with lesser catalytic activities, non-platinum catalysts can suffer from instability when exposed to ambient conditions. In particular, non-platinum catalysts can be prone to undesirable side reactions with ambient oxygen and water, thereby limiting use and potential end applications thereof.

Like hydrosilylation reactions, dehydrogenative silylation reactions are also known in the art and similarly involve a reaction between a silicon-bonded hydrogen and aliphatic unsaturation. However, in dehydrogenative silylation, the aliphatic unsaturation is vinylically bonded to silicon. Dehydrogenative silylation reactions may be utilized to prepare unsaturated compounds (e.g., olefin-functional compounds) which may further undergo additional functionalization and/or coupling reactions (e.g., via hydrosilylation).

Unfortunately, catalysts for dehydrogenative silylation reactions suffer many of the same drawbacks associated with hydrosilylation catalysts, such as sensitivity to oxygen, water, and even light. Moreover, while such drawbacks have been overcome with recent advances in hydrosilylation catalyst, many catalytic systems suitable for hydrosilylation reactions are not practical for use in dehydrogenative silylation reactions. For example, many such catalysts exhibit selectivity favoring the addition reaction, especially for minimally substituted olefins, thus leading to unselective reactions with undesirable product mixtures and low yields. Additionally, many conventional dehydrogenative silylation conditions are not functional group tolerant, and thus are limited in application.

### SUMMARY

A process for preparing a vinyl-functional chlorosilane comprises a dehydrogenative silylation reaction of a silicon-bonded hydrogen of (A) a hydridochlorosilane and (B) ethylene in the presence of (C) a heterogeneous metal catalyst.

### BRIEF DESCRIPTION OF THE DRAWING

FIG. 1 shows a schematic of process equipment for preparing a vinyl-functional chlorosilane according to this invention.

### REFERENCE NUMERALS

100 schematic of process equipment
101 vaporizer
102 reactor
102a cavity
102b heterogeneous metal catalyst
103 condenser
104 distillation apparatus
105 hydridochlorosilane feed line
106 gaseous hydridochlorosilane exit line
107 ethylene feed line
108 gas feed line
109 reactor effluent line
110 condenser exit line
111 recycle line
112 purge line
113 liquid crude line
114 vinyl-functional chlorosilane line
115 by-product exit line

### DETAILED DESCRIPTION

The starting materials used in the process introduced above, are further described as follows:

### (A) Hydridochlorosilane

Starting material (A) is used in the process described herein is a hydridochlorosilane, i.e., an organosilicon compound having at least one silicon-bonded hydrogen atom (i.e., a Si—H group), and at least one silicon-bonded chlorine atom (i.e., a Si—Cl group). The hydridochlorosilane may have the general formula R₍₃₋ₓ₎HSiClₓ, where subscript x is 1 to 3, alternatively 1 or 2; and each R is an independently selected alkyl group of 1 to 18 carbon atoms. For example, when subscript x is 1 or 2, the hydridochlorosilane may be an organohydridochlorosilane. For example, subscript x may be 1, such that (A) the hydridochlorosilane may be an organohydridochlorosilane, which may comprise a diorganohydridochlorosilane of formula R₂HSiCl. Alternatively, subscript x may be 2, such that the organohydridochlorosilane comprises an organohydridodichlorosilane of formula RHSiCl₂. Alternatively, subscript x may be 3, where (A) the hydridochlorosilane may be trichlorosilane (HSiCl₃). Alternatively, combinations of hydridochlorosilanes may be utilized, e.g., where subscript x has an average value such that 1<x<3. Alternatively, combinations of organohydridochlorosilanes may be utilized, e.g., where subscript x has an average value such that 1<x<2.

In the formulas for the organohydridochlorosilane described above, each R is an independently selected alkyl group of 1 to 18 carbon atoms. Alkyl groups suitable for R may independently be linear, branched, cyclic, or combinations thereof. Examples of suitable alkyl groups include methyl, ethyl, propyl (e.g. isopropyl and/or n-propyl), butyl (e.g. isobutyl, n-butyl, tert-butyl, and/or sec-butyl), pentyl (e.g. isopentyl, neopentyl, and/or tert-pentyl); and hexyl, octyl, decyl, and dodecyl, as well as branched saturated hydrocarbon groups, e.g., having from 6 to 18 carbon atoms. Alternatively, the alkyl group for R may have 1 to 16, alternatively 1 to 14, alternatively 1 to 12, alternatively 1 to 10, alternatively 1 to 8, alternatively 1 to 6, alternatively 1 to 4, and alternatively 1 to 2 carbon atoms.

When subscript x is 1, such that the organohydridochlorosilane is a diorganohydridochlorosilane, each R may be the same as or different from the other R in the diorganohydridochlorosilane. Alternatively, each R may be the same as each other R in the diorganohydridochlorosilane. Alternatively, when, e.g., subscript x=2, one R may be different from another R in another molecule of the organohydridochlorosilane in the formula shown above. Alternatively, each R may be independently selected from methyl groups and ethyl groups. Alternatively, each R may be methyl. For example, the organohydridochlorosilane may have the formula HSiClₓ(CH₃)₍₃₋ₓ₎, where subscript x is 1 or 2 as described above. Alternatively, the organohydridochlorosilane may comprise chlorodimethylsilane (i.e., of formula HSiCl(CH₃)₂), dichloromethylsilane (i.e., of formula (CH₃)HSiC₂), diisopropylchlorosilane (i.e., of formula HSiCl(CH(CH₃)₂)) or a combination thereof. Alternatively, the organohydridochlorosilane may comprise chlorodimethylsilane, dichloromethylsilane, or a combination thereof. Alternatively, the organohydridochlorosilane may comprise, alternatively may be, chlorodimethylsilane. Organohydridochlorosilanes such as chlorodimethylsilane are known in the art and are commercially available, e.g., from Sigma Aldrich of St. Louis, Missouri, USA. Other organohydridochlorosilanes, such as diisopropylchlorosilane are commercially available from Gelest, Inc. of Morrisville, Pennsylvania, USA.

### (B) Ethylene

Starting material (B) in the process described herein is ethylene. Ethylene is utilized in gaseous form in, or as, starting material (B). The ethylene is not limited, and may be used in neat form (i.e., free from, alternatively substantially free from other components or compounds). Said differently, starting material (B) may consist of, alternatively may consist essentially of, ethylene, or may comprise ethylene in combination with other components. Alternatively, the dehydrogenative silylation reaction process described herein may include introducing a reactor fluid comprising, alternatively consisting essentially of, alternatively consisting of, ethylene into a reactor comprising at least starting material (C) the heterogeneous metal catalyst. The reactor fluid may comprise components other than the ethylene, such as a carrier vehicle, which, as will be understood by those of skill in the art, will typically comprise (or be) a substance that is inert under the reaction conditions utilized in the dehydrogenative silylation process (i.e., will not react with the starting materials (A), (B), and (C)). Examples of such carrier vehicles include inert gasses such as nitrogen (N₂), helium (He), argon (Ar), and combinations thereof.) Alternatively, (B) the ethylene may be utilized in neat form, and consists essentially of ethylene (i.e., and is substantially free from, alternatively free from, a carrier vehicle). Ethylene is known in the art and is commercially available, e.g., from Sigma Aldrich of St. Louis, Missouri, USA.

The dehydrogenative silylation reaction process may utilize any amount of starting materials (A) and (B) and, more specifically, may comprise (A) the hydridochlorosilane and the (B) ethylene in varying amounts or ratios contingent on desired properties of the reaction (e.g. conversion rates) and/or characteristics of the starting materials employed. Typically, starting material (B), the ethylene, is utilized in at least a 1:1 stoichiometric ratio based on the number of silicon-bonded hydrogen groups, per molecule, of starting material (A), the hydridochlorosilane, to be vinylated (i.e., the number of Si—H groups capable of undergoing the dehydrogenative silylation reaction). As such, the amount of the (B) ethylene is typically selected based on the amount, type, and solubility of starting material (A), as will be understood by those of skill in the art. An excess, or gross excess, of (B) the ethylene may be utilized in order to maximize the degree of conversion of (A) the hydridochlorosilane to the vinyl-functional chlorosilane. For example, starting materials (A) and (B) may be utilized in a 1:>1 stoichiometric (molar) ratio (A):(B). Alternatively, the ethylene may be utilized in an amount sufficient to provide a mole ratio of (B) the ethylene to (A) the hydridochlorosilane of 1:1 to 100:1, such as 1:1 to 50:1, alternatively 1:1 to 25:1, alternatively 1:1 to 20:1, alternatively 1:1 to 15:1, alternatively 1:1 to 10:1, alternatively 2:1 to 10:1, and alternatively 2:1 to 6:1 (B):(A). Higher or lower ratios may also be utilized. For example, a gross excess of (B) the ethylene may be utilized (e.g. in a mole ratio of >100:1 (B):(A)).

### (C) Heterogeneous Metal Catalyst

Starting material (C) is a heterogeneous metal catalyst. The heterogeneous metal catalyst comprises Rhenium (Re) and a support. The heterogeneous metal catalyst may be prepared by any convenient means, such as incipient wetness of the support using a Re compound. For example, the Re compound may comprise dirhenium decacarbonyl, of formula Re₂(CO)₁₀, ReCl₅, Re₃Cl₉, NH₄ReO₄ and HReO₄, which are commercially available, for example, from Sigma-Aldrich. The Re compound may be dissolved in a solvent, such as THF, and then mixed with the support. Thereafter, the solvent may be removed by, e.g., heating and/or reduced pressure. After removal of the solvent, further heat treatment allows for the removal of organics and volatile inorganics from the Re compound, thus leaving Re metal particles on the support as the heterogeneous catalyst. The support is not critical, and the support may be selected from the group consisting of activated carbon, graphite, silicon carbide, alumina, ceria, silica, magnesium oxide, and calcium oxide, all of which are commercially available. Alternatively, the support may be activated carbon or alumina.

Alternatively, the heterogeneous metal catalyst may optionally further comprise an additional metal (i.e., a metal other than Rhenium). The additional metal may be selected from the group consisting of silver (Ag), cobalt (Co), nickel (Ni), palladium (Pd), and iridium (Ir). Alternatively, the additional metal may be any one of Ag, Co, Ni, Pd, or Ir. Alternatively, the additional metal may be selected from the group consisting of Ag and Co. The heterogeneous metal catalyst comprising Re and a support and an additional metal may be prepared as described above, e.g., incipient wetness of the support using an Re compound and an additional metal compound. Solutions of the Re compound and the additional metal compound may be mixed with the support in any order, e.g., the solvent solution of the Re compound described above may be mixed with the support, the solvent may be removed by heating, and thereafter the additional metal compound (dissolved in solvent) may be mixed with the support, and thereafter the solvent may be removed. Alternatively, a solvent solution of the additional metal compound may be mixed with the support, the solvent may be removed, and thereafter the solution of the Re compound may be mixed with the support.

The amount of (C) the heterogeneous metal catalyst is sufficient to catalyze the dehydrogenative silylation reaction of the silicon-bonded hydrogen of (A) the hydridochlorosilane and (B) the ethylene. The exact amount of (C) the heterogeneous metal catalyst depends on various factors including the type of reactor used for the process and the flow rates of (A) the hydridochlorosilane and (B) the ethylene. For example, the reactor used in the process may be any reactor suitable for contacting gases and solids, such as a fixed-bed reactor, a fluidized bed reactor, or an autoclave reactor. The heterogeneous metal catalyst may be placed in the fixed-bed or fluidized bed reactor, and the ethylene and the hydridochlorosilane may be fed into the reactor either individually or as a mixture. Alternatively, (C) the heterogeneous metal catalyst can be placed in an autoclave reactor, or supported in a catalyst basket therein.

### Process Steps

The process for making the reaction product comprising the vinyl-functional chlorosilane is described herein. The process comprises: optionally pre-1) reducing (C) the heterogeneous metal catalyst comprising Rhenium and a support as described above;
1) contacting in a reactor, under conditions to effect dehydrogenative silylation reaction, starting materials comprising
   (A) the hydridochlorosilane of formula R₍₃₋ₓ₎HSiClₓ, where each R is the independently selected alkyl group having from 1 to 18 carbon atoms, and subscript x is 1 to 3 (as described above);
   (B) ethylene (as described above); and
   where (A) the hydridochlorosilane and (B) the ethylene are each in a gaseous phase; optionally an inert gas; and
   where the dehydrogenative silylation reaction is performed in the presence of (C) the heterogeneous metal catalyst (as described above);
   thereby preparing a reactor effluent comprising the vinyl-functional chlorosilane.

The process may optionally further comprise one or more additional steps. The additional step may be selected from the group consisting of:
2) cooling the reactor effluent after step 1), thereby condensing materials comprising the vinyl-functional chlorosilane and optionally unreacted (A) hydridochlorosilane;
3) gas/liquid separation after step 2);
4) recycling unreacted gaseous ethylene after step 2) or step 3);
5) recycling the unreacted hydridochlorosilane after any one or more of step 1), step 2), step 3), step 4) and step 6);
6) purifying the vinyl-functional chlorosilane; and
7) repeating step 1) using the gaseous ethylene from step 4) and/or the unreacted hydridochlorosilane from step 5); and
two or more of steps 2) to 7).

### Step Pre-1) Reducing the Heterogeneous Metal Catalyst.

Step pre-1) in the process described above is reducing (C) the heterogeneous metal catalyst. Reducing the heterogeneous metal catalyst may be performed by any convenient means. Reducing may comprise heating the reactor containing the (C) the heterogeneous metal catalyst at a temperature of >100° C. to 500° C., alternatively 100° C. to 400° C., and alternatively 200° C. to 300° C., with exposure to hydrogen or a mixture of hydrogen and an inert gas, such as nitrogen or argon.

### Step 1)

In step 1) of the process described above, both (A) the hydridochlorosilane and (B) the ethylene are in the gas phase. The reactor used in step 1) may be any reactor suitable for contacting gases and solids, as described above. For example, (C) the heterogeneous metal catalyst may be placed in the reactor, and the starting materials comprising (B) the ethylene and (A) the hydridochlorosilane may be fed into the reactor either individually or as a mixture in step 1). The gaseous hydridochlorosilane and ethylene (and any other starting materials, such as the inert gas described above) may be fed at a flow rate and a contact time effective to bring about the dehydrogenative silylation reaction at the selected pressure and temperature. Alternatively, (C) the heterogeneous metal catalyst can be placed in an autoclave reactor, or supported in a catalyst basket therein, and the starting materials comprising (A) the hydridochlorosilane and (B) the ethylene may be charged and maintained at the selected temperature and pressure to effect the dehydrogenative silylation reaction in step 1).

The temperature in step 1) is sufficient to effect dehydrogenative silylation reaction and may be >125° C., alternatively at least 200° C., while at the same time the temperature may be <400° C., alternatively up to 300° C. Alternatively, the temperature in step 1) may be >125° C. to <400° C.; alternatively the temperature may be 200° C. to 300° C.

The reactor in step 1) may optionally be pressurized with ethylene (e.g., via a gas manifold). Alternatively, starting materials (A) and (B) may be provided in the reactor at ambient pressure, alternatively 90 kPa to 500 psi (3447.4 kPa), alternatively 90 kPa to 690 kPa, 100 kPa±10 kPa. Alternatively, a higher pressure may be used. One skilled in the art would balance productivity and other factors, such as capital cost, when designing equipment to perform step 1) of the process. Inert gas may optionally be added during step 1). For example, nitrogen or argon may be used to optimize the process step 1).

### Additional Steps

The process described above may further comprise one or more additional steps, as described above, which may be performed in any convenient order. For example, in step 2) the reactor effluent may be cooled, e.g., to RT or to a temperature<125° C., or to any temperature sufficient to condense the vinyl-functional chlorosilane and/or any unreacted hydridochlorosilane. Unreacted ethylene may be collected via a gas/liquid separation in step 3), and the unreacted ethylene may optionally be recycled in the process in step 1).

The process described above may further comprise step 6) purifying the vinyl-functional chlorosilane from the reactor effluent. Purifying the vinyl-functional chlorosilane refers to increasing the relative concentration of the vinyl-functional chlorosilane as compared to other compounds in combination therewith (e.g., in the reactor effluent after step 1), or in a purified version thereof, e.g., if the gas/liquid separation and/or recycling steps described above are performed). As is understood in the art, purifying may comprise removing the other compounds from such a combination (i.e., decreasing the amount of impurities/other components combined with the vinyl-functional chlorosilane in the reactor effluent) and/or removing the vinyl-functional chlorosilane itself from the combination. Any suitable technique and/or protocol for purification may be utilized, e.g. distilling, stripping/evaporating, extracting, filtering, washing, partitioning, phase separating, and chromatography, as well as combinations thereof, e.g., in sequence or as part of a single procedure. Regardless of the particular technique selected, purification of the vinyl-functional chlorosilane may be performed in sequence (i.e., in line) with the reaction itself, and thus may be automated. Alternatively, purification may be a stand-alone procedure to which the reactor effluent comprising the vinyl-functional chlorosilane is subjected.

Distillation to purify the vinyl-functional chlorosilane may be performed at sub-atmospheric pressure and temperature (i.e., reduced temperature and reduced pressure). The reduced pressure and temperature will be selected by one of skill in the art in view of the reaction conditions and parameters selected, the starting materials utilized, the vinyl-functional chlorosilane prepared. The reduced pressure is typically operated as a vacuum, although any reduced pressure between vacuum and atmospheric pressure of 101.325 kPa may be utilized. For example, the reduced pressure may be >0 to 50, alternatively >0 to 40, alternatively >0 to 30, alternatively >0 to 20, alternatively >0 to 10, alternatively >0 to 5, alternatively >0 to 4, alternatively >0 to 3, alternatively from >0 to 2 kPa.

Any unreacted hydridochlorosilane may also be recovered during gas/liquid separation during step 3) and/or during purification in step 6), e.g., the distillation step described above, and the process may further comprise step 5) in which the unreacted hydridochlorosilane may optionally be recycled in the process in step 1). Step 5) may be performed before or after step 6), described above. The process may optionally further comprise step 7) repeating step 1). In step 7), the ethylene recovered via gas/liquid separation in step 3), the unreacted hydridochlorosilane recovered as described above, or both the ethylene and the unreacted hydridochlorosilane, may be recycled.

The product produced by the process described above is a vinyl-functional chlorosilane of formula (CH₂═CH—)R₍₃₋ₓ₎SiClₓ, where each R is the independently selected alkyl group of 1 to 18 carbon atoms, and subscript x is 1 to 3, alternatively 1 or 2, as described above. Alternatively, the vinyl-functional chlorosilane may be a vinyl-functional organochlorosilane may having a formula selected from the group consisting of (CH₂═CH—)R₂SiCl, (CH₂═CH—)RSiCl₂, and a combination thereof. Alternatively, the vinyl-functional organochlorosilane may comprise vinyldimethylchlorosilane, vinylmethyldichlorosilane, or a combination thereof. The vinyl-functional chlorosilane prepared according to the process described above may be utilized in diverse end use applications, e.g. as a discrete component in a composition, such as a curable composition, e.g., a hydrosilylation reaction curable composition.

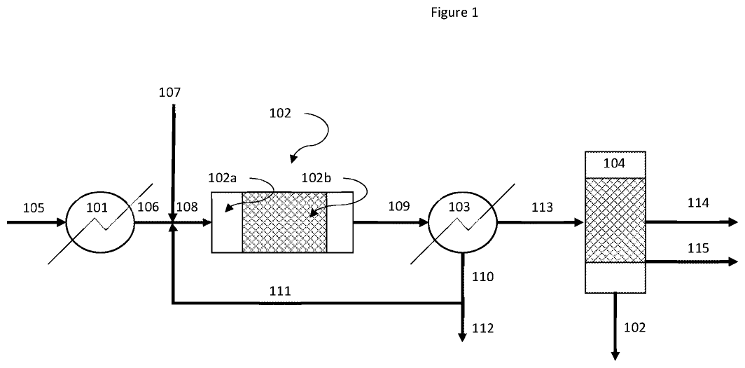

Equipment suitable for performing the process described above is illustrated by the schematic in FIG. 1. The process equipment 100 comprises a vaporizer 101 upstream of a fixed bed reactor 102 upstream of a condenser 103 upstream of a distillation apparatus 104. The hydridochlorosilane may be fed as a liquid to the vaporizer 101 via hydridochlorosilane feed line 105. The hydridochlorosilane, such as dimethylchlorosilane, is heated and vaporized by the vaporizer 101. The hydridochlorosilane (now in the gaseous phase) exits the heater via gaseous hydridochlorosilane exit line 106. Ethylene is introduced via ethylene feed line 107. The ethylene and hydridochlorosilane, both in the gaseous phase, are fed into the reactor 102 via gas feed line 108. The reactor 102 defines a cavity 102a, which houses the heterogeneous metal catalyst 102b. The gaseous hydridochlorosilane and ethylene contact the heterogeneous metal catalyst 102b inside the reactor 102, and a dehydrogenative silylation reaction occurs, as exemplified below in Scheme 1, where the hydridochlorosilane is dimethylchlorosilane. One or more of hydrogen, ethane, and ethyldimethylchlorosilane may be produced as side products of the dehydrogenative silylation reaction.

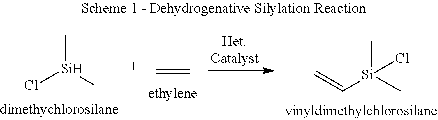

Reactor effluent passes out of the reactor 102 and into the condenser 103 via reactor effluent line 109. The reactor effluent comprises unreacted ethylene, by-product ethane, and vinyl-functional chlorosilane product (e.g., vinyldimethylchlorosilane in Scheme 1, above). When the reactor effluent is cooled in the condenser 103, unreacted ethylene and by-product ethane may be separated out via condenser exit line 110 and recycled into the reactor 102 via recycle line 111 or discarded via purge line 112. Liquid crude product exits the condenser via liquid exit line 113, and the liquid crude can be fed into the distillation apparatus 104. The vinyl-functional chlorosilane and any by-products, such as an ethyl-functional chlorosilane, may be separated in different distillation cuts. The vinyl-functional chlorosilane may exit the distillation apparatus 104 via vinyl-functional chlorosilane line 114, and any remaining by-products may exit the distillation apparatus 104 via by-product exit line 115.

One skilled in the art would recognize that FIG. 1 shows an example, and other means for practicing the process described herein are within the scope of the invention. For example, instead of feeding ethylene with the gaseous hydridochlorosilane into the reactor 102, the ethylene may be introduced directly into the reactor 102 by moving ethylene feed line 107. Alternatively, the ethylene feed line 107 may introduce ethylene upstream or downstream of any recycle line 111. Recycling unreacted ethylene is optional, and therefore, recycle line 111 may be omitted. The fixed bed reactor 102 may be replaced with a fluidized bed reactor, a multitubular reactor, which distributes the hydridochlorosilane and from gaseous feed line 108 into a plurality of smaller tubes, or other type of reactor suitable for contacting gases and solids. Alternatively, two or more reactors suitable for contacting gases and solids may be used in series to improve conversion or in parallel, such that when the heterogeneous metal catalyst in a first reactor is spent, the hydridochlorosilane and ethylene may be fed to a second reactor with fresher catalyst so as to continue production while the heterogeneous metal catalyst in the first reactor is regenerated or replaced.

### EXAMPLES

These examples are intended to illustrate the invention to one skilled in the art and are not to be interpreted as limiting the scope of the invention set forth in the claims. Starting materials used in these examples are described in Table 1.

TABLE 1
Starting Materials

| Ingredient | | Chemical Description, Chemical | |
|---|---|---|---|
| Type | Product Name | formula, or Structure | Source |
| Process | Chlorodimethylsilane | HSiMe₂Cl or Me₂HSiCl | Gelest |
| starting | | | |
| material | | | |
| Process | ethylene | C₂H₄ | Air gas |
| starting | | | |
| material | | | |
| Catalyst | 5% hydrogen in argon | 5% H₂ in Ar | Air gas |
| reducer | | | |
| Carrier | 5% nitrogen in argon | 5% N₂ in Ar | Air gas |
| gas | | | |
| Support | Activated carbon | Cabot, Norit RX 3 Extra | Cabot |
| Support | ALAP C1-5 α-alumina | alumina | Saint |
| | support | | Gobain/Norpro |
| Support | Cabot NORIT 3 EXTRA | Activated carbon | Cabot |
| Catalyst | 3% Re on activated carbon | Re deposited from Re₂(CO)₁₀ | CP Example 1 |
| | | onto activated carbon by | |
| | | incipient wetness | |
| Catalyst | 3% Ru/C | Ruthenium on activated carbon | Johnson |
| | | | Matthey |
| Catalyst | 10% Cu on Alumina | Catalyst containing Copper on | CP Example 2 |
| | | a-alumina | |
| Catalyst | Rhenium carbonyl | Re₂(CO)₁₀ | Strem |
| Precursor | | | |
| Solvent | Toluene | Toluene | Aldrich |
| Solvent | THF | Tetrahydrofuran | Aldrich |
| Solvent | Ethylene glycol | | CP Example 2 |
| Catalyst | 3% Ni on Carbon | 3% nickel on activated carbon | CP Example 3 |
| Catalyst | 1% Pt/C | Platinum on activated carbon | Degussa |
| Catalyst | 5% Pd/C | Palladium on activated carbon | Ketjen Catalyst |
| Catalyst | Bis(cyclopentadienyl)Ni(0), | Nickel supported by 1,5- | Strem |
| Precursor | Ni(COD)₂ | cyclooctadiene | |
| Catalyst | Copper Nitrate | saturated copper nitrate/ | Aldrich |
| Precursor | | water solution | |
| Internal | Nonane | | |
| Standard | | | |
| Catalyst | Silver Nitrate | Saturated silver nitrate/ | Aldrich |
| Precursor | | water solution | |
| Catalyst | Ruthenium (III) chloride | Saturated ruthenium | Aldrich |
| Precursor | hydrate | chloride/water solution | |
| Catalyst | Iridium (IV) Chloride | Saturated iridium chloride/ | Aldrich |
| Precursor | hdyrodate | water solution | |
| Catalyst | Gold (III) Chloride | Saturated gold chloride/ | Aldrich |
| Precursor | | water solution | |
| Catalyst | Cobalt(II) Nitrate | Saturated cobalt nitrate/ | Aldrich |
| Precursor | hexahydrate | water solution | |
| Catalyst | Nickel(II) Nitrate | Saturated nickel nitrate/ | Aldrich |
| Precursor | hexahydrate | water solution | |
| Catalyst | Palladium (II) Nitrate | Saturated palladium nitrate/ | Aldrich |
| Precursor | dihydrate | water solution | |

### CATALYST PREPARATION (CP) EXAMPLES

### CP Example 1: Preparation of 3% Re on Activated Carbon

In a glove box, ajar was charged with activated carbon (1.00 g, Cabot NORIT 3 EXTRA) and a solution of Re₂(CO)₁₀ (0.0542 g) dissolved in THF (1 mL) was added dropwise with gentle shaking. The carbon was allowed to stand for 30 minutes and then the THF was removed in vacuo for 15 h at RT. A total of 1.110 g was isolated suggesting some THF was not removed during evacuation.

### CP Example 2: Preparation of 10% Cu/a-Al₂O₃

A 20 mL vial was charged with 6.79 mL of a saturated copper nitrate/water solution (density=1.67 g/mL) and 7.02 mL of distilled water. The vial was then charged with 1.41 mL of ethylene glycol. The cap was placed on the vial and it was shaken vigorously for 30 seconds to mix the contents.

4.931 g of ALAP C1-5 α-alumina support (Lot #BL073321, SS070636 TB) was then added to the solution in the vial. The support was allowed to soak in the solution for 3 hours before being removed and placed in a small ceramic dish.

The dish was transferred to an air-purged (20 L/min) Lindberg Blue M furnace and heated to 88° C. at a rate of 2°/min, held at 88° C. for 10 h, heated to 260° C. at a rate of 2° C./min, held at 260° C. for 90 minutes, then allowed to cool to room temperature. Once cool, the sample was collected and weighed (5.497 g).

### CP Example 3: Preparation of ˜3% Ni on Activated Carbon

In a glove box, ajar was charged with activated carbon (1.00 g, Cabot NORIT 3 EXTRA) and a solution of Bis (cyclooctadiene)nickel (0) (0.145 g) largely dissolved in toluene (2 mL) was added dropwise to the carbon with gentle shaking at 60° C. A small portion of solid Ni(COD)₂ that did not dissolve was not added to the support. The carbon was allowed to stand for 10 minutes and then the volatiles were removed in vacuo for 1 h at RT. A total of 1.31 g was isolated suggesting some toluene was not removed.

### Comparative Example 1—Gas Phase Dehydrogenative Silylation of Ethylene with Chlorodimethylsilane Using 3% Ru on Activated Carbon

A heterogeneous metal catalyst 3 wt % Ru/C (1.38 g, extrudates, provided by Johnson Matthey) was loaded into the middle of a reactor tube made of Inconel (⅜″ OD). The length of the packed catalyst bed was 3 inches long. The catalyst was packed in between two beds of quartz beads (approximately 6-8 inches each). The reactor tube was connected to the flow setup and the catalyst was reduced under H₂/N₂ flow (90 sccm each) at temperatures ranging from 100-300° C. for a cumulative 5 hours. Chlorodimethylsilane (HSiMe₂Cl) was fed into the reactor via a bubbler with N₂ as the carrier gas using a mass flow controller. Ethylene gas was fed into the reactor from a cylinder equipped with a pressure regulator via a mass flow controller. The ethylene/SiH ratio was kept constant at 2 mol/mol throughout the entire experiment. All feed lines to the reactor were preheated to 170° C. Throughout the experiment, the temperature of the reactor varied from 200-400° C. The flow rates of the gases were adjusted accordingly to obtain residence times ranging approximately 3-5 seconds. The back-pressure regulator was bypassed to maintain atmospheric pressure in the reactor. The reactor outlet was connected through a 3-way valve assembly that was used for periodic sample injection to an online GC/TCD/MS for qualitative and quantitative analysis of the reagents and products. The feed line to the GC was heat traced and maintained at 150° C. A dry ice trap was used downstream of the reactor to condense the products. Results are shown in Table 2. This example demonstrates that dehydrogenative silylation of Me₂HSiCl with ethylene, both in the gas phase, using a Ru/C catalyst, results in a reaction product with a Vi/Et ratio much less than 1, unlike what was shown in Patent Application Publication WO2021-127179 for dehydrogenative silylation with liquid phase homogeneous Ru catalysts.

TABLE 2
Product distribution (wt %) obtained by on-line GC analysis from the dehydrogenative
silylation of chlorodimethylsilane with ethylene over Ru/C.

| | | Vi/Et | | | | | | |
|---|---|---|---|---|---|---|---|---|
| GC | Temp | Ratio^{a} | Me₃SiH | Me₂HSiCl | Me₃SiCl | Me₂SiCl₂ | Me₂SiViCl | EtMe₂SiCl |
| Sample | ° C. | Mol/mol | wt % | wt % | wt % | wt % | wt % | wt % |
| 1 | 200 | 0.13 | 2.27 | 24.96 | 0.28 | 8.05 | 0.95 | 7.32 |
| 2 | 200 | 0.14 | 0.7 | 39.06 | 0.11 | 2.28 | 0.46 | 3.28 |
| 3 | 200 | 0.16 | 0.59 | 41.14 | 0 | 1.12 | 0.35 | 2.16 |
| 4 | 200 | 0.17 | 0.51 | 47.29 | 0 | 0.79 | 0.26 | 1.51 |
| 5 | 200 | 0.16 | 0.53 | 44.08 | 0 | 0.77 | 0.26 | 1.58 |
| 6 | 300 | 0.09 | 0.67 | 37.06 | 0.22 | 2.34 | 0.2 | 2.15 |
| 7 | 300 | 0.125 | 0.57 | 40.44 | 0.11 | 1.28 | 0.12 | 0.96 |
| 8 | 300 | NA | 0.61 | 43.39 | 0 | 0.99 | 0.09 | 0 |
| 9 | 300 | NA | 0.68 | 44.07 | 1.2 | 1.13 | 0.09 | 0 |
| 10 | 300 | NA | 0.61 | 49.93 | 0 | 0.95 | 0 | 0 |
| 11 | 300 | NA | 0.5 | 53.62 | 0 | 0.64 | 0 | 0 |
| 12 | 400 | 0.051 | 0.86 | 42.22 | 0 | 6.11 | 0.12 | 2.35 |
| 13 | 400 | 0.076 | 0.71 | 30.92 | 0 | 4.59 | 0.2 | 2.64 |

^{a}NA denotes ethylchlorodimethylsilane was below GC detection limit

### Comparative Example 2—Recycling Ru/C

The same catalyst used in Comparative Example 1 was also used for this Comparative Example 2. Refer to Comparative Example 1 for catalyst loading and preparation. Prior to this experiment, the catalyst was reduced for a second time under H₂/N₂ flow (90/180 sccm, respectively) at a temperature of 500° C. for 1.5 hours. Chlorodimethylsilane (HSiMe₂Cl) was fed into the reactor via a bubbler with N₂ as the carrier gas using a mass flow controller. Ethylene gas was fed into the reactor from a cylinder equipped with a pressure regulator via a mass flow controller. All feed lines to the reactor were preheated to 170° C. Throughout the experiment, the temperature of the reactor was held constant at 300° C. The total flow rate of the ethylene and chlorodimethylsilane gases was held constant to obtain a constant residence time of 3 seconds. The ethylene:SiH ratio was varied throughout the experiment at 2-5 mol/mol. The back pressure regulator was bypassed to maintain atmospheric pressure in the reactor. The reactor outlet was connected through a 3-way valve assembly that was used for periodic sample injection to an online GC/TCD/MS for qualitative and quantitative analysis of the reagents and products. The feed line to the GC was heat traced and maintained at 150° C. A dry ice trap was used downstream of the reactor to condense the products. Results are shown in Table 3. This example demonstrates that using the Ru/C heterogeneous catalyst does not catalyze a dehydrogenative silylation reaction sufficiently; each sample tested produced a product with a Vi/Et ratio much less than 1 even with varying the Ethylene:SiH ratio under the conditions tested.

TABLE 3
Product distribution (wt %) obtained by on-line GC analysis from the
dehydrogenative silylation of Me₂HSiCl with ethylene over Ru/C.

| | | Ethylene:SiH | Vi/Et | | | | | | |
|---|---|---|---|---|---|---|---|---|---|
| | Temp | Ratio | Ratio^{a} | Me₃SiH | Me₂HSiCl | MeSiCl₃ | Me₂SiCl₂ | Me₂SiViCl | EtMe₂SiCl |
| Sample | ° C. | mol/mol | mol/mol | wt % | wt % | wt % | wt % | wt % | wt % |
| 2 | 300 | 5 | 0.46 | 0 | 36.27 | 0 | 0 | 0.06 | 0.13 |
| 3 | 300 | 5 | 0.38 | 0 | 32.6 | 0.28 | 0.1 | 0.12 | 0.32 |
| 4 | 300 | 5 | 0.56 | 0 | 28.82 | 0.37 | 0.12 | 0.05 | 0.09 |
| 5 | 300 | 2 | 0.18 | 0 | 45.69 | 0.35 | 0.06 | 0.09 | 0.49 |
| 6 | 300 | 2 | 0.16 | 0 | 43.63 | 0.04 | 0.04 | 0.05 | 0.31 |
| 7 | 300 | 2 | NA | 0 | 46.75 | 0.32 | 0.1 | 0 | 0.25 |

^{a}NA was used when ethylchlorodimethylsilane was below GC detection limit

### Comparative Example 3—Gas Phase Dehydrogenative Silylation of Ethylene with Chlorodimethylsilane Using 21% Ru on Alumina

A heterogeneous metal catalyst 21 wt % Ru/Al₂O₃ (0.96 g, spheres) was loaded into the middle of a reactor tube made of Inconel (⅜″ OD). The length of the packed catalyst bed was 3 inches long. The catalyst was packed in between two beds of quartz beads (approximately 6-8 inches each). The reactor tube was connected to the flow setup and the catalyst was reduced under H₂/N₂ flow (60/180 sccm, respectively) at temperatures ranging from 100-300° C. for a cumulative 5 hours. Chlorodimethylsilane was fed into the reactor via a bubbler with N₂ as the carrier gas using a mass flow controller. Ethylene gas was fed into the reactor from a cylinder equipped with a pressure regulator via a mass flow controller. Throughout the experiment, the temperature of the reactor was held constant at 300° C. The total flow rate of the gases was held constant to obtain a constant residence time of 3 seconds. The Ethylene:SiH ratio was varied throughout the experiment from 2-10 mol/mol. The back-pressure regulator was bypassed to maintain atmospheric pressure in the reactor. The reactor outlet was connected through a 3-way valve assembly that was used for periodic sample injection to an online GC/TCD/MS for qualitative and quantitative analysis of the reagents and products. The feed line to the GC was heat traced and maintained at 150° C. A dry ice trap was used downstream of the reactor to condense the products. Results are shown in Table 4. This example showed that the attempted gas phase dehydrogenative silylation of chlorodimethylsilane with ethylene using a Ru/Al₂O₃ catalyst produced a product with Vi/Et ratio less than 1 mol/mol over the majority of a course of a run, indicating poor selectivity to the desired product under the conditions tested. Only one initial measurement showed a desired Vi/Et ratio, but this performance was not sustained during additional measurements.

TABLE 4
Product distribution (wt %) obtained by on-line GC analysis from the
dehydrogenative silylation of Me₂HSiCl with ethylene over Ru/Al₂O₃.

| | | Ethylene:SiH | Vi/Et | | | | | | |
|---|---|---|---|---|---|---|---|---|---|
| | Temp | Ratio | Ratio^{a} | Me₃SiH | Me₂HSiCl | Me₃SiCl | Me₂SiCl₂ | Me₂SiViCl | EtMe₂SiCl |
| Sample | ° C. | mol/mol | mol/mol | wt % | wt % | wt % | wt % | wt % | wt % |
| 1 | 300 | 5 | 1.20 | 0.7 | 13.67 | 1.32 | 5.63 | 7.35 | 6.14 |
| 2 | 300 | 5 | 0.71 | 0.26 | 27.76 | 0.4 | 1.16 | 1.05 | 1.48 |
| 3 | 300 | 5 | 0.36 | 0.23 | 26.99 | 0.32 | 0.98 | 0.49 | 1.35 |
| 4 | 300 | 5 | 0.28 | 0 | 17.73 | 0.23 | 0.38 | 0.34 | 1.2 |
| 5 | 300 | 5 | 0.20 | 0.21 | 27.03 | 0.32 | 0.94 | 0.24 | 1.23 |
| 6 | 300 | 2 | 0.10 | 0.23 | 35.85 | 0.41 | 0 | 0.17 | 1.67 |
| 7 | 300 | 2 | 0.08 | 0.21 | 32.75 | 0.35 | 0 | 0.14 | 1.66 |
| 8 | 300 | 2 | 0.07 | 0.22 | 33.9 | 0.39 | 0 | 0.12 | 1.77 |
| 9 | 300 | 2 | 0.06 | 0.23 | 35.73 | 0.42 | 0 | 0.11 | 1.97 |
| 10 | 300 | 10 | 0 | 0 | 11.41 | 0 | 0 | 0 | 1.14 |
| 11 | 300 | 10 | 0 | 0 | 11.64 | 0 | 0 | 0 | 0.15 |
| 12 | 300 | 10 | 0.11 | 0 | 14.77 | 0 | 0 | 0.08 | 0.7 |

^{a}NA was used when ethylchlorodimethylsilane was below GC detection limit

### Comparative Example 4—Liquid Phase Reaction of Ethylene and Chlorodimethylsilane with Ru/C

A heterogeneous metal catalyst 3 wt % Ru/C (506 mg, extrudates, provided by Johnson Matthey) was loaded into the middle of a reactor tube made of Inconel (⅜″ OD). The reactor tube was connected to the flow setup and the catalyst was reduced under H₂/N₂ flow (90 sccm each) at temperatures ranging 100-300° C. for a cumulative 5 hours. The reactor was then purged with excess N₂, sealed and transferred to an inerted glovebox. In the glovebox, a 50 mL solution of toluene (30.15 g) and chlorodimethylsilane (13.54 g) was made in a glass screw-top container. 1.13 g of nonane were also added as an internal reference standard for gas chromatographic analysis. 1 g of solution was weighed out in a separate glass vial and combined with 4 g of toluene to measure the starting concentration of chlorodimethylsilane by gas chromatography. The remaining solution was then transferred to a 100 mL Parr reactor. The catalyst was then loaded into the reactor vessel to make a slurry solution. The reactor was sealed and removed from the glovebox. The Parr reactor was connected to the system and the lines were purged with nitrogen for 10 minutes. The reactor was then purged with 100 psig of ethylene three times with 1 minute of stirring when pressurized. After purging, the reactor was pressurized with 200 psig of ethylene under continuous stirring at 350 rpm. The reactor was fed with ethylene until pressure was stable at 200 psig. After saturation, the reactor was sealed and heated to 40° C. under stirring at 350 rpm. After a 10-minute stabilization period, the reactor was further heated to 100° C. under a controlled temperature ramp of 2° C./min to prevent temperature overshoot. The reactor temperature was held at 100° C. for 120 minutes, after which the heating was stopped, and the reactor was cooled with an external fan. Once cooled to room temperature, the reactor was depressurized and then purged three times with 100 psig of nitrogen. After one final depressurization, the reactor was connected to 10 psig nitrogen flow, and this pressure was used to transfer the reactor solution to a stainless-steel sample cylinder. The cylinder was sealed and then transported into an inerted glovebox, where the solution was collected in a glass vial. A 1 g aliquot was collected in a separate vial, diluted with 4 g of toluene and analyzed by gas chromatography to determine solution composition after the dehydrogenative coupling reaction. The resulting reaction solution indicated a SiH conversion of 66% and selectivity of 12% (mol Si) Me₂ViSiCl. This product mixture was then reused to carry out an additional reaction identical to the above with the exception that the reactor temperature was held at 200° C. for 120 minutes. The resulting reaction solution indicated a SiH conversion of 100% and selectivity of 48% (mol Si) Me₂ViSiCl. This example demonstrates that Me₂ViSiCl can be produced by the dehydrogenative silylation of ethylene with chlorodimethylsilane in the liquid phase (slurry) using a Ru/C catalyst. Using a heterogeneous Ru catalyst with liquid phase reactants provided different results than the same metal (Ru) as catalyst with gaseous reactants (see Comparative Example 1). Without wishing to be bound by theory, it is thought that dehydrogenative silylation performs differently in the gas phase than liquid phase, therefore, one skilled in the art would not have a reasonable expectation of success to arrive at the present invention based on literature with a liquid phase hydridosilane reactant, which is not predictive of performance for the present invention, in which both the ethylene and the organohydridochlorosilane are in the gas phase during the dehydrogenative silylation reaction.

### Working Example 1: Gas Phase Dehydrogenative Silylation of Ethylene with Chlorodimethylsilane Using 3% Re on Activated Carbon

A catalyst sample of Re/C prepared according to CP Example 1 above (0.5 g) was sized to 30/50 mesh, and loaded into a ¼″ diameter reactor tube and held in place between quartz wool plugs with the remaining reactor volume filled with quartz chips. The reactor was heated to 100° C. with flow of nitrogen (200 sccm) and held for 1 h. The catalyst was then reduced by heating to 350° C. with flow of 5% hydrogen in argon and holding for 3 h. The reactor was cooled to 125° C. with flow of nitrogen. The flow of nitrogen was stopped and a ˜5:1 mixture of ethylene and chlorodimethylsilane was delivered to the reactor. This was accomplished by bubbling 5% nitrogen in argon (8 sccm) through neat chlorodimethylsilane at ambient temperature and combining the resulting vapors with ethylene (60 sccm). After 3.33 h, the reactor was heated to 200° C. with continued reactant gas flow for 3 h, and then 300° C. for 4 h and 400° C. for 4 h. Throughout the experiment, product mixtures were analyzed by an inline Agilent 7890A GC equipped with a Restek CC1263 column and a TCD detector. Test methods and calculations were performed as described below. Chlorodimethylsilane conversion, typical ratio of vinylchlorodimethylsilane to ethylchlorodimethylsilane and selectivity for producing silicon-containing species at a given temperature as determined by GC are shown below in Table 5.

TABLE 5
Results with Re/C Catalyst

| Temp | conversion | Vi/Et | selectivity to Si containing products (mol %) | | | | |
|---|---|---|---|---|---|---|---|
| (° C.) | (%) | Ratio | Me₂SiViCl | EtMe₂SiCl | Me₂SiCl₂ | Me₃SiCl | Me₃SiH |
| 125 | 1.7 | 0.2 | 16.0 | 68.5 | 15.5 | 0.0 | 0.0 |
| 200 | 5.6 | 1.0 | 42.9 | 42.1 | 8.3 | 0.0 | 6.8 |
| 300 | 3.4 | 5.2 | 66.3 | 12.7 | 20.2 | 0.8 | 0.0 |
| 400 | 3.7 | 0.5 | 13.6 | 27.9 | 38.6 | 3.2 | 16.8 |

The data in Table 5 show that at a temperature of 200° C. to 300° C., a reaction product with a Vi/Et ratio≥1 was prepared using a heterogeneous catalyst comprising Re and a support under the conditions tested.

### Comparative Example 5: No Metal

The procedure in Working Example 1 was followed except that the activated carbon support was used directly without any metal impregnation, instead of the catalyst. Chlorodimethylsilane conversion, typical ratio of vinylchlorodimethylsilane to ethylchlorodimethylsilane and selectivity for producing silicon-containing species at a given temperature was determined by GC and is shown below in Table 6.

TABLE 6
Results with Activated Carbon Support Alone

| Temp | conversion | Vi/Et | selectivity to Si containing products (mol %) | | | | |
|---|---|---|---|---|---|---|---|
| (° C.) | (%) | ratio^{a} | Me₂SiViCl | EtMe₂SiCl | Me₂SiCl₂ | Me₃SiCl | Me₃SiH |
| 125 | 0.2 | N/A | 0.0 | 0.0 | 100.0 | 0.0 | 0.0 |
| 200 | 0.2 | N/A | 0.0 | 0.0 | 100.0 | 0.0 | 0.0 |
| 300 | 0.3 | N/A | 0.0 | 0.0 | 100.0 | 0.0 | 0.0 |
| 400 | 3.0 | 0.3 | 9.1 | 30.9 | 43.5 | 2.8 | 13.8 |

^{a}N/A = Ethylchorodimethylsilane is not detectable

### Comparative Example 6: Gas Phase Dehydrogenative Silylation of Ethylene with Chlorodimethylsilane Using 3% Ru on Activated Carbon

The procedure in Working Example 1 was followed, except that the catalyst was replaced with 3% Ru on carbon and the 125° C. and 400° C. temperature conditions were omitted. Chlorodimethylsilane conversion, typical ratio of vinylchlorodimethylsilane to ethylchlorodimethylsilane and selectivity for producing silicon-containing species at a given temperature as determined by GC are shown below in Table 7.

TABLE 7
Results with Ru/C

| Temp | conversion | Vi/Et | selectivity to Si containing products (mol %) | | | | |
|---|---|---|---|---|---|---|---|
| (° C.) | (%) | ratio | Me₂SiViCl | EtMe₂SiCl | Me₂SiCl₂ | Me₃SiCl | Me₃SiH |
| 200 | 7.23 | 0.22 | 14.7 | 66.3 | 7.4 | 0.6 | 11.0 |
| 300 | 3.02 | 0.42 | 16.4 | 39.0 | 19.4 | 1.0 | 24.3 |

### Comparative Example 7

The procedure in Working Example 1 was followed except that the catalyst used was 10% Cu on a-Al₂O₃.

Chlorodimethylsilane conversion, typical ratio of vinylchlorodimethylsilane to ethylchlorodimethylsilane and selectivity for producing silicon-containing species at a given temperature for inventive and comparative catalysts determined by GC. Results of this Comparative Example 7 are shown below in Table 8.

TABLE 8

| Temp | conversion | Vi/Et | selectivity to Si containing products (mol %) | | | | |
|---|---|---|---|---|---|---|---|
| (° C.) | (%) | ratio^{a} | Me₂SiViCl | EtMe₂SiCl | Me₂SiCl₂ | Me₃SiCl | Me₃SiH |
| 125 | 1.16 | 0 | 0.0 | 7.8 | 56.9 | 0.0 | 35.3 |
| 200 | 72.79 | 0.21 | 0.6 | 28.2 | 29.8 | 22.4 | 19.0 |
| 300 | 56.9 | 0.53 | 11.0 | 20.6 | 29.2 | 21.8 | 17.4 |
| 400 | 0.32 | N/A | 0.0 | 0.0 | 100.0 | 0.0 | 0.0 |

^{a}N/A = Ethylchorodimethylsilane is not detectable

### Comparative Example 8

The procedure in Working Example t was followed except that the catalyst used was 3% Ni on activated carbon and the catalyst was reduced at 350° C.

Chlorodimethylsilane conversion, typical ratio of vinylchlorodimethylsilane to ethylchlorodimethylsilane and selectivity for producing silicon-containing species at a given temperature for inventive and comparative catalysts determined by GC, as shown below in Table 9.

TABLE 9

| Temp | conversion | Vi/Et | selectivity to Si containing products (mol %) | | | | |
|---|---|---|---|---|---|---|---|
| (° C.) | (%) | ratio^{a} | Me₂SiViCl | EtMe₂SiCl | Me₂SiCl₂ | Me₃SiCl | Me₃SiH |
| 125 | 0.4 | N/A | 0.0 | 18.9 | 81.1 | 0.0 | 0.0 |
| 200 | 0.43 | N/A | 0.0 | 18.4 | 71.1 | 10.5 | 0.0 |
| 300 | 0.33 | N/A | 0.0 | 0.0 | 100.0 | 0.0 | 0.0 |
| 400 | 3.61 | 0.36 | 10.4 | 28.8 | 36.8 | 2.4 | 21.5 |

^{a}N/A = Ethylchorodimethylsilane is not detectable

### Comparative Example 9: Gas Phase Dehydrogenative Silylation of Ethylene with Chlorodimethylsilane Using 1% Pt on Activated Carbon

The procedure in Working Example 1 was followed except that the catalyst used was 1% Pt on carbon and the 125° C. and temperature soak was omitted.

Chlorodimethylsilane conversion, typical ratio of vinylchlorodimethylsilane to ethylchlorodimethylsilane and selectivity for producing silicon-containing species at a given temperature as determined by GC, are shown below in Table 10.

TABLE 10

| temp | conversion | Vi/Et | selectivity to Si containing products (mol %) | | | | |
|---|---|---|---|---|---|---|---|
| (deg C.) | (%) | ratio | Me₂SiViCl | EtMe₂SiCl | Me₂SiCl₂ | Me₃SiCl | Me₃SiH |
| 200 | 3.0 | 0.0 | 0.0 | 89.2 | 10.8 | 0.0 | 0.0 |
| 300 | 2.7 | 0.1 | 8.2 | 77.4 | 14.4 | 0.0 | 0.0 |
| 400 | 5.1 | 0.2 | 6.3 | 28.3 | 59.8 | 5.6 | 0.0 |

### Comparative Example 10: Gas Phase Dehydrogenative Silylation of Ethylene with Chlorodimethylsilane Using 5% Pd on Activated Carbon

The procedure in Working Example 1 was followed except that the catalyst used was 1% Pd on carbon and the 125° C. and temperature soak was omitted.

Chlorodimethylsilane conversion, typical ratio of vinylchlorodimethylsilane to ethylchlorodimethylsilane and selectivity for producing silicon-containing species at a given temperature as determined by GC are shown below in Table 11.

TABLE 11

| temp | conversion | Vinyl/Ethyl | selectivity to Si containing products (mol %) | | | | |
|---|---|---|---|---|---|---|---|
| (deg C.) | (%) | ratio^{a} | Me₂SiViCl | EtMe₂SiCl | Me₂SiCl₂ | Me₃SiCl | Me₃SiH |
| 200 | 0.3 | 0.0 | 0.0 | 25.6 | 66.7 | 7.7 | 0.0 |
| 300 | 0.3 | 0.0 | 0.0 | 19.4 | 80.6 | 0.0 | 0.0 |
| 400 | 3.2 | 0.3 | 10.9 | 36.5 | 32.8 | 2.3 | 17.5 |

Comparative Examples 7 to 10 show that not all metals can catalyze dehydrogenative silylation of ethylene and chlorodimethylsilane with an Vi/Et ratio≥1 under the conditions tested. Using copper, nickel, platinum, or palladium heterogeneous metal catalysts produced reaction products with poor conversion and poor selectivity to the desired dimethylvinylchlorosilane.

### CP Example 4: Re/C Catalyst Preparation Via Automated Process

500 mg of support material was added to a round bottom vial. Multiple vials were used to prepare larger batches of a single catalyst. These were placed in a vertical shaker table. Using automated dosing pumps, a solution of metal precursor (Re₂(CO)₁₀) in THF solvent was dosed into each vial with enough volume to fill the pores of the support to its incipient point. The concentration of metal precursor in the solution was determined by the target amount of metal.

After solution addition, the shaker table was activated to ensure liquid filled all pores of the catalyst support material. Next, the catalysts were dried at 120° C. under inert gas flow overnight. After drying, the catalysts were loaded in an oven where they were heated to 120° C. for 3 hours and then ramped up to 500° C. for 12 hours. Finally, the catalysts were cooled down to 100° C. The entire heating and cooling sequence occurred with constant flow of 100 sccm of 5 vol % hydrogen in nitrogen to allow the metals to be reduced to their metallic state.

### CP Example 5: 3% Re/C Manual Catalyst Preparation

1 g of support material (e.g. Cabot NORIT 3 Extra activated carbon sized using 30-100 mesh sieves) was added to a vial. A solution of dirhenium decacarbonyl (Re₂(CO)₁₀) (0.0542 g) dissolved in THF (1 mL) was added dropwise while mixing with a spatula to distribute evenly throughout. The THF was removed by vacuum oven overnight or by regular oven at 120° C. The catalyst was then moved to a pre-reduction furnace at 120° C. for 3 hours, followed by 500° C. for 12 hours. Finally, the catalyst was cooled to 100° C.

### CP Example 6: 3% Re/C Manual Catalyst Preparation

Inside a glove box, ajar was charged with activated carbon (9.7 g, Carbon Resources, previously vacuum dried at 120° C.) and a solution of Re₂(CO)₁₀ (0.53 g dissolved in 10 mL THF) was added dropwise with gentle shaking. The carbon was allowed to stand for 2 h inside the glovebox and then dried on a hot plate at 120° C. in a fume hood. Based on the starting weights of the rhenium salt and carbon support, the composition was calculated to be 3% Re/C (w/w), which was stored in a sample vial for activity testing.

### CP Example 7: Re Multimetallic Catalyst Synthesis Via Automated Process

In a typical synthesis, 500 mg of support material was added a round bottom vial. Multiple vials were used to prepare different catalyst compositions or larger batches of a single catalyst. These were placed in a vertical shaker table. Using automated dosing pumps, an aqueous solution of metal precursor was dosed into each vial with enough volume to fill the pores of the support to its incipient point. The concentration of metal precursor in the solution was determined by the target amount of metal for a particular catalyst.

Once the first metal solution was dosed, the catalysts were dried at 120° C. under inert gas flow overnight. Next, the second metal solution was dosed as in the first addition to the dried catalysts with simultaneous shaking.

After the second solution addition, the catalysts were loaded in an oven where they were heated to 120° C. for 3 hours and then ramped up to 500° C. for 12 hours. Finally, the catalysts were cooled down to 100° C. The entire heating and cooling sequence occurred with a constant flow of 100 sccm of 5 vol % hydrogen in nitrogen to allow the metals to be reduced to their metallic state.

The total metal loading ranged between 3 wt % to 10 wt % and the molar ratios between the metals (Metal 1:Metal 2 molar ratio) was 3:1, 1:1 or 1:3 mol/mol. Table 12 lists the metal combinations in the heterogeneous metal catalysts synthesized.

TABLE 12
Synthesized multimetallic catalyst
following CP Example 7 procedure

| | | | | Metal 1: Metal 2 |
|---|---|---|---|---|
| Metal 1 | Metal 2 | Wt % Metal 1 | Wt % Metal 2 | Molar ratio |
| Re | Ag | 1.44 | 2.50 | 0.33 |
| Re | Ag | 2.86 | 1.72 | 0.97 |
| Re | Ag | 4.72 | 0.94 | 2.90 |
| Re | Co | 1.46 | 1.46 | 0.32 |
| Re | Co | 2.88 | 0.96 | 0.95 |
| Re | Co | 4.74 | 0.51 | 2.93 |
| Re | Ni | 1.46 | 1.46 | 0.32 |
| Re | Ni | 2.88 | 0.96 | 0.95 |
| Re | Ni | 4.74 | 0.51 | 2.92 |
| Re | Pd | 1.44 | 2.50 | 0.33 |
| Re | Pd | 2.87 | 1.62 | 1.01 |
| Re | Pd | 4.72 | 0.90 | 3.01 |
| Re | Ru | 1.44 | 2.40 | 0.33 |
| Re | Ru | 2.87 | 1.53 | 1.02 |
| Re | Ru | 4.72 | 0.85 | 3.02 |
| Re | Ir | 2.83 | 2.83 | 1.03 |
| Re | Ir | 2.88 | 0.96 | 3.10 |
| Re | Ir | 1.50 | 4.69 | 0.33 |
| Ru | Ag | 1.41 | 4.52 | 0.33 |
| Ru | Ag | 2.82 | 3.01 | 1.00 |
| Ru | Ag | 2.86 | 1.67 | 1.83 |
| Ru | Co | 1.44 | 2.59 | 0.32 |
| Ru | Co | 2.86 | 1.72 | 0.97 |
| Ru | Co | 2.89 | 0.91 | 1.84 |
| Ru | Ni | 1.44 | 2.59 | 0.32 |
| Ru | Ni | 2.86 | 1.72 | 0.97 |
| Ru | Ni | 2.89 | 0.91 | 1.83 |
| Ru | Re | 1.44 | 2.87 | 0.96 |
| Ir | Re | 2.83 | 2.83 | 0.97 |
| Ir | Re | 4.69 | 1.50 | 3.03 |
| Ir | Re | 1.42 | 4.25 | 0.32 |
| Ag | Re | 1.72 | 2.86 | 1.05 |
| Co | Re | 0.96 | 2.88 | 1.08 |
| Ni | Re | 1.63 | 5.30 | 1.01 |
| Pd | Re | 1.62 | 2.87 | 1.03 |
| Ru | Re | 1.44 | 2.87 | 0.96 |

### Working Example 2: General Procedure for Gas Phase Dehydrogenative Silylation of Ethylene with Chlorodimethylsilane Using Parallel Quartz Reactors

Quartz reactor tubes of 152 mm and id of 3 mm were loaded with a heterogeneous metal catalyst (made according to an example described above, e.g., CP Example 4, 5, or 7) to create a ˜40 mm heated zone, loaded by volume. Quartz chips and quartz wool are packed at the top and bottom to hold the catalyst bed in place. The 16 tubes were loaded into a common manifold for gas delivery and placed inside a metal block that was electrically heated via a clamshell element. The reactor was then heated up to 350° C. under 100 sccm of Ar, which was distributed evenly over the 16 tubes via a microfluidic flow chip. The temperature was then increased to 500° C. for 3 hours under a 50/50 mixture of H₂ and Ar, which flowed at 100 sccm total flow rate. This was also evenly distributed over the 16 tubes. The temperature was then decreased back to the reaction temperature under a flow of Ar. Once the reaction temperature was reached, the chlorodimethylsilane and ethylene flows were started. The chlorodimethylsilane was delivered via an ISCO syringe pump at a total flow rate of 0.055 mL/min and the ethylene was fed at a rate of 60 sccm. They were mixed in a quartz-chip-filled vaporizer set at 180° C. The flow was then equally distributed over each of the 16 tubes via the microfluidic flow chip. Residence time in each reactor tube was approximately 1.7 seconds.

### Working Example 3: Gas Phase Dehydrogenative Silylation of Ethylene with Chlorodimethylsilane Using 3% Re/C in Parallel Quartz Reactors

A catalyst sample prepared according to CP Example 5 was tested according to Working Example 2 conditions. The resulting performance for this catalyst is listed in Table 13, which was the average of six GC measurements over a period of six hours:

TABLE 13
Results with 3% Re/C Catalyst

| Temp | conversion | Vi/Et | selectivity to Si containing products (mol %) | | | | |
|---|---|---|---|---|---|---|---|
| (° C.) | (%) | Ratio | Me₂SiViCl | EtMe₂SiCl | Me₂SiCl₂ | Me₃SiCl | Me₃SiH |
| 250 | 5.4 | 2.6 | 69.1 | 26.9 | 4.0 | 0.0 | 0.0 |
| 300 | 3.5 | 6.4 | 60.7 | 9.5 | 28.1 | 0.0 | 6.8 |

### Working Example 4: Gas Phase Dehydrogenative Silylation of Ethylene with Chlorodimethylsilane Using 10% Re/C in Parallel Quartz Reactors

A catalyst sample prepared according to CP Example 5 was tested according to Working Example 2 conditions. The resulting performance for this catalyst is listed in Table 14, which is the average of six GC measurements over a period of six hours:

TABLE 14
Results with 10% Re/C Catalyst

| Temp | conversion | Vi/Et | selectivity to Si containing products (mol %) | | | | |
|---|---|---|---|---|---|---|---|
| (° C.) | (%) | Ratio | Me₂SiViCl | EtMe₂SiCl | Me₂SiCl₂ | Me₃SiCl | Me₃SiH |
| 300 | 3.9 | 3.3 | 60.4 | 18.2 | 21.4 | 0.0 | 6.8 |

### Working Example 5—Gas Phase Dehydrogenative Silylation of Ethylene with Dimethylchlorosilane Using Re/C Catalyst

A 3 wt. % Re/C catalyst (2.5 grams, synthesized following CP Example 6) was loaded into the middle of a reactor tube made of Inconel (⅜″ OD). The length of the packed catalyst bed was approximately 2 inches long. The catalyst was packed in between two beds of quartz beads (approximately 6-8 inches each). The reactor tube was connected to the flow setup and the catalyst was reduced under H₂/N₂ flow (50/200 SCCM each) at 300° C. temperature for 4 hours. Dimethylchlorosilane (Me₂HSiCl) was fed into the reactor via a bubbler (kept at ambient temperature) with N₂ as the carrier gas using a mass flow controller. Ethylene gas was fed into the reactor from a cylinder equipped with a pressure regulator via a mass flow controller. The inlet and outlet tubing to/from the reactor was maintained at 170° C. using heat tape to prevent any condensation of reactants and products. The reaction was carried out using a mole ratio of Ethylene/Me₂HSiCl=4 feed at 250° C. and 300° C. reaction temperatures. The reactor outlet was connected through a 3-way valve assembly that was used for periodic sample injection to an online GC(TCD)-MS for qualitative and quantitative analysis of the reagents and products. The feed line to the GC was heat traced and maintained at 150° C. Results are shown in Table 15 by averaging 7 GC injections and 4 GC injections at 250 and 300° C., respectively. This example demonstrated that Me₂ViSiCl can be produced by the method of the invention in the gas phase dehydrogenative silylation of ethylene using Me₂HSiCl and a Re/C catalyst in a different reactor than the one tested in Working Example 3.

TABLE 15
Results with 3 wt % Re/C:

| Temp | conversion | Vi/Et | selectivity to Si containing products (mol %) | | | | |
|---|---|---|---|---|---|---|---|
| (° C.) | (%) | Ratio | Me₂SiViCl | EtMe₂SiCl | Me₂SiCl₂ | Me₃SiCl | Me₃SiH |
| 250 | 5.1 | 2.9 | 49.3 | 17.1 | 33.1 | 0.0 | 0.4 |
| 300 | 6.5 | 8.1 | 34.5 | 4.3 | 61.3 | 0.0 | 0.0 |

### Working Example 6: Gas Phase Dehydrogenative Silylation of Ethylene with Chlorodimethylsilane Using Re Multimetallic Catalysts in Parallel Quartz Reactors

Catalyst samples prepared according to CP Example 7 were tested according to Working Example 2 conditions. Multiple catalysts were tested in parallel in this experiment, and all contained Re as the first metal deposited. The relative amounts of Re and the second metal were varied. Their catalytic performance under the conditions of Working Example 2 are shown in Table 16 for 250° C. and Table 17 for 300° C.:

TABLE 16
Re-based multimetallic catalyst examples at 250° C., showing the second
metal in the composition as Metal 2. M1:M2 denotes the Metal 1:Metal 2 molar ratio.

| Metal | | conversion | Vi/Et | selectivity to Si containing products (mol %) | | | | |
|---|---|---|---|---|---|---|---|---|
| 2 | M1:M2 | (%) | Ratio | Me₂SiViCl | EtMe₂SiCl | Me₂SiCl₂ | Me₃SiCl | Me₃SiH |
| Ag | 0.33 | 5.1 | 2.9 | 49.3 | 17.1 | 33.1 | 0.0 | 0.4 |
| Ag | 0.97 | 6.5 | 8.1 | 34.5 | 4.3 | 61.3 | 0.0 | 0.0 |
| Ag | 2.90 | 2.30 | 0.80 | 38.90 | 46.80 | 14.30 | 0.00 | 0.00 |
| Co | 0.32 | 4.30 | 5.40 | 55.00 | 10.30 | 34.60 | 0.00 | 0.00 |
| Co | 0.95 | 8.50 | 0.90 | 1.40 | 1.60 | 97.00 | 0.00 | 0.00 |
| Co | 2.93 | 0.80 | 0.00 | 0.00 | 0.00 | 100.00 | 0.00 | 0.00 |
| Ni | 0.32 | 1.60 | 11.70 | 81.10 | 7.00 | 11.90 | 0.00 | 0.00 |
| Ni | 0.95 | 2.70 | 1.40 | 23.00 | 16.30 | 60.70 | 0.00 | 0.00 |
| Ni | 2.92 | 3.80 | 0.70 | 15.80 | 21.90 | 36.50 | 0.00 | 0.00 |
| Pd | 0.33 | 1.30 | 7.00 | 83.00 | 11.80 | 5.10 | 0.00 | 0.00 |
| Pd | 1.01 | 2.10 | 0.50 | 7.10 | 13.20 | 75.20 | 4.50 | 0.00 |
| Pd | 3.01 | 1.60 | 0.50 | 26.40 | 58.60 | 8.60 | 0.00 | 0.00 |
| Ru | 0.33 | 1.50 | 4.60 | 65.80 | 14.20 | 20.00 | 0.00 | 0.00 |
| Ru | 1.02 | 1.70 | 0.70 | 9.20 | 12.60 | 78.30 | 0.00 | 0.00 |
| Ru | 3.02 | 0.50 | 0.10 | 11.91 | 88.10 | 0.00 | 0.00 | 0.00 |
| Ir | 1.03 | 2.70 | 1.30 | 45.60 | 34.40 | 18.30 | 0.00 | 0.00 |
| Ir | 3.10 | 1.10 | 4.30 | 51.50 | 12.00 | 35.30 | 0.00 | 0.00 |
| Ir | 0.33 | 4.27 | 1.30 | 45.90 | 36.70 | 15.90 | 0.00 | 0.00 |

TABLE 17
Re-based multimetallic catalyst examples at 300° C., showing the second
metal in the composition as Metal 2. M1:M2 denotes the Metal 1:Metal 2 molar ratio.

| Metal | | conversion | Vi/Et | selectivity to Si containing products (mol %) | | | | |
|---|---|---|---|---|---|---|---|---|
| 2 | M1:M2 | (%) | Ratio | Me₂SiViCl | EtMe₂SiCl | Me₂SiCl₂ | Me₃SiCl | Me₃SiH |
| Ag | 0.33 | 3.60 | 9.10 | 56.80 | 6.20 | 37.00 | 0.00 | 0.00 |
| Ag | 0.97 | 7.70 | 3.50 | 40.10 | 11.40 | 48.50 | 0.00 | 0.00 |
| Ag | 2.90 | 2.40 | 6.90 | 20.00 | 2.90 | 77.00 | 0.00 | 0.00 |
| Co | 0.32 | 1.50 | No EtSi | 2.30 | 0.00 | 97.70 | 0.00 | 0.00 |
| Co | 0.95 | 1.30 | No EtSi | 64.40 | 0.00 | 35.60 | 0.00 | 0.00 |
| Co | 2.93 | 2.10 | 6.70 | 34.40 | 5.10 | 60.50 | 0.00 | 0.00 |
| Ni | 0.32 | 1.50 | 2.90 | 57.60 | 19.50 | 22.90 | 0.00 | 0.00 |
| Ni | 0.95 | 1.80 | 8.30 | 42.00 | 5.00 | 53.00 | 0.00 | 0.00 |
| Ni | 2.92 | 1.60 | 4.30 | 20.10 | 4.70 | 75.20 | 0.00 | 0.00 |
| Pd | 0.33 | 1.60 | 6.90 | 74.60 | 10.90 | 14.60 | 0.00 | 0.00 |
| Pd | 1.01 | 1.60 | 6.50 | 65.80 | 14.20 | 20.00 | 0.00 | 0.00 |
| Pd | 3.01 | 1.40 | 3.30 | 18.70 | 5.70 | 75.60 | 0.00 | 0.00 |
| Ru | 0.33 | 0.80 | 0.10 | 5.00 | 87.50 | 7.50 | 0.00 | 0.00 |
| Ru | 1.02 | 1.40 | 0.30 | 17.10 | 58.66 | 24.22 | 0.00 | 0.00 |
| Ru | 3.02 | 1.70 | 4.30 | 22.50 | 5.30 | 72.20 | 0.00 | 0.00 |
| Ir | 1.03 | 1.64 | 1.46 | 35.9 | 24.6 | 39.5 | 0.0 | 0.0 |
| Ir | 3.10 | 1.63 | 8.27 | 37.5 | 4.5 | 55.5 | 0.0 | 0.0 |
| Ir | 0.33 | 3.5 | 1.89 | 43.5 | 23.0 | 31.6 | 0.0 | 0.0 |

### Example 7: Gas Phase Dehydrogenative Silylation of Ethylene with Chlorodimethylsilane Using Multimetallic Catalysts Containing Re as Second Metal in Parallel Quartz Reactors

Catalyst samples prepared according to CP Example 7 were tested according to Working Example 2 conditions. Multiple catalysts were tested in parallel in this experiment, and all contained Re as the second metal deposited. The relative amounts of metals were varied. Their catalytic performance under the conditions of Working Example 1 are shown in Table 18 for 250° C. and Table 19 for 300° C.:

TABLE 18
Multimetallic catalyst examples at 250° C., showing the first metal in the composition
as Metal 1. Metal 2 was Re in all samples. M1:M2 denotes the Metal 1:Metal 2 molar ratio.

| Metal | | conversion | Vi/Et | selectivity to Si containing products (mol %)¹ | | | | |
|---|---|---|---|---|---|---|---|---|
| 1 | M1:M2 | (%) | Ratio | Me₂SiViCl | EtMe₂SiCl | Me₂SiCl₂ | Me₃SiCl | Me₃SiH |
| Ir | 0.97 | 2.60 | 1.81 | 60.90 | 33.60 | 5.38 | 0.00 | 0.00 |
| Ir | 3.03 | 2.80 | 1.79 | 49.50 | 27.60 | 22.30 | 0.22 | 0.00 |
| Ir | 0.32 | 2.10 | 1.45 | 35.40 | 24.30 | 22.40 | 0.00 | 0.00 |
| Ag | 1.05 | 1.1 | 3.39 | 15.2 | 4.5 | 65.0 | 2.1 | 0.0 |
| Co | 1.08 | 2.4 | 1.55 | 45.0 | 29.0 | 22.1 | 0.7 | 0.0 |
| Ni | 1.01 | 1.6 | 1.20 | 30.1 | 25.0 | 39.3 | 0.7 | 0.0 |
| Pd | 1.03 | 3.4 | 1.10 | 40.8 | 37.3 | 18.8 | 0.0 | 0.0 |
| Ru | 0.96 | 2.1 | 0.35 | 18.1 | 51.0 | 15.9 | 1.6 | 0.0 |

In Table 18, ¹ denotes that any deviation from 100% in this sum is due to siloxanes that were not quantified. Table 18 shows that Ruthenium may be detrimental to performance of the heterogeneous metal catalyst under certain conditions because Vi/Et ratio<1 when Ru was used as the second metal under the conditions tested in this example.

TABLE 19
Multimetallic catalyst examples at 300° C., showing the first metal in the composition
as Metal 1. Metal 2 was Re in all samples. M1:M2 denotes the Metal 1:Metal 2 molar ratio.

| Metal | | conversion | Vi/Et | selectivity to Si containing products (mol %) | | | | |
|---|---|---|---|---|---|---|---|---|
| 1 | M1:M2 | (%) | Ratio | Me₂SiViCl | EtMe₂SiCl | Me₂SiCl₂ | Me₃SiCl | Me₃SiH |
| Ir | 0.97 | 2.44 | 2.67 | 50.78 | 19.00 | 29.86 | 2.95 | 0.00 |
| Ir | 3.03 | 2.23 | 1.92 | 36.97 | 19.24 | 42.78 | 0.00 | 0.00 |
| Ir | 0.32 | 1.80 | 2.05 | 31.60 | 15.40 | 46.70 | 0.00 | 0.00 |
| Ag | 1.05 | 2.1 | 9.88 | 34.4 | 3.5 | 54.3 | 0.4 | 0.0 |
| Co | 1.08 | 1.94 | 2.07 | 34.2 | 16.5 | 47.9 | 0.0 | 0.0 |
| Ni | 1.01 | 1.54 | 1.46 | 21.1 | 14.5 | 55.1 | 0.0 | 0.0 |
| Pd | 1.03 | 2.45 | 2.89 | 46.1 | 16.0 | 36.9 | 0.0 | 0.0 |
| Ru | 0.96 | 1.2 | 0.75 | 24.5 | 32.7 | 42.8 | 0.0 | 0.0 |

Table 19 also shows that Ruthenium may be detrimental to performance of the heterogeneous metal catalyst under certain conditions because Vi/Et ratio<1 when Ru was used as the second metal under the conditions tested in this example. This example demonstrates that the presence of Re in a multimetallic composition leads to Vi/Et molar ratios>1 even if Re and the second metal are added in a different order during catalyst synthesis. Note: In Table 19, some of these samples had significant siloxane production that made the sum of selectivities not add to 100% in this table; any deviation from 100% in this sum was due to siloxanes that were not quantified.

### Comparative Example 11: Gas Phase Dehydrogenative Silylation of Ethylene with Chlorodimethylsilane Using Ru Multimetallic Catalysts in Parallel Quartz Reactors

Catalyst samples prepared according to CP Example 7 were tested according to Working Example 2 conditions. Multiple catalysts were tested in parallel in this experiment, and all contained Ru as the first metal deposited. The relative amounts of Ru and the second metal were varied. Their catalytic performance under the conditions of Working Example 1 are shown in Table 20 for 250° C. and Table 21 for 300° C.:

TABLE 20
Ru-based multimetallic catalyst examples at 250° C., showing the second
metal in the composition as Metal 2. M1:M2 denotes the Metal 1:Metal 2 molar ratio.

| Metal | | conversion | Vi/Et | selectivity to Si containing products (mol %) | | | | |
|---|---|---|---|---|---|---|---|---|
| 2 | M1:M2 | (%) | Ratio | Me₂SiViCl | EtMe₂SiCl | Me₂SiCl₂ | Me₃SiCl | Me₃SiH |
| Ag | 0.33 | 0.70 | 0.00 | 0.00 | 0.00 | 100.00 | 0.00 | 0.00 |
| Ag | 1.00 | 2.40 | 0.00 | 0.00 | 0.00 | 100.00 | 0.00 | 0.00 |
| Ag | 1.83 | 2.10 | 0.00 | 0.00 | 0.00 | 100.00 | 0.00 | 0.00 |
| Co | 0.32 | 0.00 | 0.00 | 0.00 | 0.00 | 0.00 | 0.00 | 0.00 |
| Co | 0.97 | 0.70 | 0.00 | 0.00 | 0.00 | 100.00 | 0.00 | 0.00 |
| Co | 1.84 | 0.70 | 0.00 | 0.00 | 0.00 | 100.00 | 0.00 | 0.00 |
| Ni | 0.32 | 14.90 | 0.40 | 10.00 | 26.40 | 47.10 | 0.00 | 0.70 |
| Ni | 0.97 | 0.70 | 0.00 | 0.00 | 0.00 | 100.00 | 0.00 | 0.00 |
| Ni | 1.83 | 0.70 | 0.00 | 0.00 | 0.00 | 100.00 | 0.00 | 0.00 |

TABLE 21
Ru-based multimetallic catalyst examples at 300° C., showing the second
metal in the composition as Metal 2. M1:M2 denotes the Metal 1:Metal 2 molar ratio.

| Metal | | conversion | Vi/Et | selectivity to Si containing products (mol %) | | | | |
|---|---|---|---|---|---|---|---|---|
| 2 | M1:M2 | (%) | Ratio | Me₂SiViCl | EtMe₂SiCl | Me₂SiCl₂ | Me₃SiCl | Me₃SiH |
| Ag | 0.33 | 1.00 | 0.00 | 0.00 | 0.00 | 100.00 | 0.00 | 0.00 |
| Ag | 1.00 | 2.20 | 0.00 | 0.00 | 0.00 | 100.00 | 0.00 | 0.00 |
| Ag | 1.83 | 1.30 | 0.00 | 0.00 | 0.00 | 100.00 | 0.00 | 0.00 |
| Co | 0.32 | 0.00 | 0.00 | 0.00 | 0.00 | 0.00 | 0.00 | 0.00 |
| Co | 0.97 | 0.70 | 0.00 | 0.00 | 0.00 | 100.00 | 0.00 | 0.00 |
| Co | 1.84 | 0.80 | 0.00 | 0.00 | 0.00 | 100.00 | 0.00 | 0.00 |
| Ni | 0.32 | 2.80 | 0.00 | 0.00 | 0.00 | 58.10 | 0.00 | 0.00 |
| Ni | 0.97 | 0.70 | 0.00 | 0.00 | 0.00 | 100.00 | 0.00 | 0.00 |
| Ni | 1.83 | 0.58 | 0.00 | 0.00 | 0.00 | 100.00 | 0.00 | 0.00 |

### INDUSTRIAL APPLICABILITY

This invention provides a process for preparing vinyl-functional chlorosilanes with Vi/Et ratio≥1, calculated as described below in Table 14. The heterogeneous rhenium catalyst used herein provides the unexpected benefit of selectivity to dehydrogenative silylation reaction resulting in desired vinyl-functional chlorosilane products. Use of gaseous reactants in the process described herein provides the benefits of not needing: i) high pressure, ii) solvent, or iii) catalyst recycle/recovery.

### Definitions and Usage of Terms

Unless otherwise indicated by the context of the specification: the articles ‘a’, ‘an’, and ‘the’ each refer to one or more; and the singular includes the plural. The SUMMARY and ABSTRACT are hereby incorporated by reference. The terms “comprising” or “comprise” are used herein in their broadest sense to mean and encompass the notions of “including,” “include,” “consist(ing) essentially of,” and “consist(ing) of. The use of “for example,” “e.g.,” “such as,” and “including” to list illustrative examples does not limit to only the listed examples. Thus, “for example” or “such as” means “for example, but not limited to” or “such as, but not limited to” and encompasses other similar or equivalent examples.

The abbreviations used herein have the definitions in Table 22.

TABLE 22
Abbreviations

| Abbreviation | Definition |
|---|---|
| ° C. | Degrees Celsius |
| HSiMe₂Cl or | Chlorodimethylhydridosilane |
| Me₂HSiCl | or chlorodimethylsilane |
| cm | centimeter |
| COD | Cyclooctadiene |
| Et | ethyl |
| EtMe₂SiCl | ethyldimethylchlorosilane |
| g | gram |
| GC | Gas chromatography |
| h | hour |
| Hz | Hertz |
| m | meter |
| Me | methyl |
| Me₂SiCl₂ | dimethyldichlorosilane |
| Me₃SiCl | trimethylchlorosilane |
| Me₃SiH | trimethylsilane |
| min | minute |
| mL | milliliter |
| mm | millimeter |
| mol | mole |
| MS | mass spectrometry |
| OD | outside diameter |
| RT | room temperature of 23° C. +/− 2° C. |
| sccm | Standard cubic centimeters per minute |
| TCD | Thermal conductivity detection |
| μm | micrometer |
| Vi | vinyl |
| Me₂ViCl | vinyldimethylchlorosilane |
| wt | weight |

### Test Methods and Calculations

The Working Examples and Comparative Examples described above were analyzed as follows: An on-line analysis was completed utilizing an Agilent (7890A) GC instrument equipped with a TCD detector, which was connected to the product vapor line. Quantification of the reactor effluent gas composition was completed using the response factors and retention times determined using a calibration gas cylinder that contained known amounts of EtMe₂SiCl, ViMe₂SiCl, Me₃SiH, Me₃SiCl, and Me₂SiCl₂. A remote sampling system was used to transfer sample from the reactor product line to the GC inlet. Specifics of GC instrument and program details are summarized in Table 23.

TABLE 23

| Instrument | Agilent 7890A Gas Chromatograph | | |
|---|---|---|---|
| Capillary Column | | | |
| Type | Rtx-DCA custom column (Restek | | |
| | Corporation, Cat # CC1263) | | |
| Length | 40 m | | |
| Inner Diameter | 0.18 mm | | |
| Film Thickness | 0.4 μm | | |
| Outlet Pressure | Ambient | | |
| Transfer Line 1 | | | |
| Type | Uncoated Fused Silica | | |
| Length | 40 cm | | |
| Inner Diameter | 0.25 mm | | |
| Outlet | TCD | | |
| Inlet | | | |
| Type | Split/Split less | | |
| Temperature | 225° C. | | |
| Liner Type | Unpacked Inverted Cup Splitter | | |
| | (Restek Corporation, Cat # 20709) | | |
| Mode | Split | | |
| Split Ratio | 50:1 | | |
| Carrier Gas | | | |
| Type | Helium (99.999%, Airgas Corporation) | | |
| Flow rate | 1.5 mL/min | | |
| Mode | Constant Flow | | |
| Oven Program | 40° C. hold for 1 minute, ramp at | | |
| | 6°/min to 150° C. and hold for 0 min | | |
| Valves | n/a | | |
| | Time | Valve | Set point |
| Timetable | 0.01 | 1 | ON |
| | 0.4 | 1 | OFF |
| Detector | | | |
| Type | Thermal Conductivity (Back Detector) | | |
| Temperature | 250° C. | | |
| Reference Flow rate | 25 mL/min | | |
| Makeup Flow rate | 5 mL/min | | |
| Makeup Gas Type | He | | |
| Negative Polarity | Off | | |
| Signal 1 | | | |

| | |
|---|---|
| Data Rate | 20 Hz |
| Type | Front Detector |
| Save Data | On |
| Zero | 0.0 (Off) |
| Range | 0 |
| Fast Peaks | Off |
| Attenuation | 0 |
| Sample Loop Volume | 0.5 mL |

In the Working Examples and Comparative Examples above, Conversion, Vi/Et ratio, and Vi selectivity were calculated as shown below in Table 24. In Table 24, experimental result calculations: ‘in’=material is fed into reactor; ‘out’=material is leaving reactor; and ‘SiH’ denotes dimethylchlorosilane.

TABLE 24
Calculations

| | |
|---|---|
| Conversion | $100 * \frac{[ Moles SiH in ] - [ Moles SiH out ]}{[ Moles SiH in ]}$ |
| Vi/Et ratio | $\frac{[ Moles ViSiMe2Cl out ]}{[ Moles EtSi out ]}$ |
| Vi selectivity | $\frac{100 * [ Moles ViSiMe2Cl out ]}{[ Moles SiH in ] - [ Moles SiH out ]}$ |

### EMBODIMENTS OF THE INVENTION

In a first embodiment, a process for making a reaction product comprising a vinyl-functional organochlorosilane comprises:
1) contacting in a reactor, under conditions to effect dehydrogenative silylation reaction comprising heating at a temperature of >100° C. to <400° C., starting materials comprising
   (A) an organohydridochlorosilane of formula R₂HSiCl, where each R is an independently selected alkyl group having from 1 to 18 carbon atoms; and
   (B) ethylene;
   where (A) the organohydridochlorosilane and (B) the ethylene are each in a gaseous phase; and
   where the dehydrogenative silylation reaction is performed in the presence of (C) a heterogeneous metal catalyst comprising Rhenium and a support;
thereby preparing a reactor effluent comprising the vinyl-functional organochlorosilane.

In a second embodiment, the process of the first embodiment further comprises reducing (C) the heterogeneous metal catalyst before step 1).

In a third embodiment, in the process of the second embodiment, reducing (C) the heterogeneous metal catalyst comprises heating the reactor containing (C) the heterogeneous metal catalyst at a temperature of >100° C. to 400° C. with exposure to hydrogen or a mixture of hydrogen and an inert gas.

In a fourth embodiment, in the process of any one of the first to third embodiments, step 1) comprises heating (A) the organohydridochlorosilane, (B) the ethylene, and (C) the heterogeneous metal catalyst at a temperature of at a temperature of 200° C. to 300° C.

In a fifth embodiment, the process of any one of the first to fourth embodiments further comprises an additional step, and the additional step is selected from the group consisting of:
2) cooling the reactor effluent after step 1), thereby condensing materials comprising the vinyl-functional organochlorosilane and optionally unreacted (A) organohydridochlorosilane;
3) gas/liquid separation after step 2);
4) recycling unreacted gaseous ethylene after step 2) or step 3);
5) recycling the unreacted organohydridochlorosilane;
6) purifying the vinyl-functional organochlorosilane; and
7) repeating step 1) using the gaseous ethylene from step 4) and/or the unreacted organohydridochlorosilane from step 5); and
two or more of steps 2) to 7).

In a sixth embodiment, in the process of any one of the first to fifth embodiments, the organohydridochlorosilane comprises chlorodimethylsilane (Me₂HSiCl).

In a seventh embodiment, in the process of any one of the first to sixth embodiments, the support is selected from the group consisting of activated carbon, graphite, silicon carbide, alumina, ceria, silica, magnesium oxide, and calcium oxide.

In an eighth embodiment, the process of any one of the first to seventh embodiments further comprises, before step 1) preparing (C) the heterogeneous metal catalyst by a process comprising depositing Re₂(CO)₁₀ on the substrate via incipient wetness.

In a ninth embodiment, in the process of any one of the first to eighth embodiments, the vinyl-functional organochlorosilane has formula (CH₂═CH—)R₂SiCl, where each R is an independently selected monovalent hydrocarbon group of 1 to 18 carbon atoms.

In a tenth embodiment, in the process of the ninth embodiment, the vinyl-functional organochlorosilane comprises vinyldimethylchlorosilane.

1. A process for making a reaction product comprising a vinyl-functional chlorosilane, wherein the process comprises:
1) contacting in a reactor, under conditions to effect dehydrogenative silylation reaction, starting materials comprising
(A) a hydridochlorosilane of formula R₍₃₋ₓ₎HSiClₓ, where each R is an independently selected alkyl group having from 1 to 18 carbon atoms, and subscript x is 1 to 3; and
(B) ethylene;
where (A) the hydridochlorosilane and (B) the ethylene are each in a gaseous phase; and
where the dehydrogenative silylation reaction is performed in the presence of (C) a heterogeneous metal catalyst comprising Rhenium and a support;
thereby preparing a reactor effluent comprising the vinyl-functional chlorosilane.

2. The process of claim 1, where step 1) comprises heating at a temperature of >125° C. and <400° C.

3. The process of claim 2, where the temperature is 200° C. to 300° C.

4. The process of claim 1, further comprising reducing (C) the heterogeneous metal catalyst before step 1).

5. The process of claim 4, where reducing (C) the heterogeneous metal catalyst comprises heating the reactor containing the (C) the heterogeneous metal catalyst at a temperature of >100° C. to 500° C. with exposure to hydrogen or a mixture of hydrogen and an inert gas.

6. The process of claim 1, where the process further comprises an additional step, and the additional step is selected from the group consisting of:
2) cooling the reactor effluent after step 1), thereby condensing materials comprising the vinyl-functional chlorosilane and optionally unreacted (A) hydridochlorosilane;
3) gas/liquid separation after step 2);
4) recycling unreacted gaseous ethylene after step 2) or step 3);
5) recycling the unreacted hydridochlorosilane;
6) purifying the vinyl-functional chlorosilane; and
7) repeating step 1) using the gaseous ethylene from step 4) and/or the unreacted hydridochlorosilane from step 5); and
two or more of steps 2) to 7).

7. The process of claim 1, where the hydridochlorosilane has formula R₂HSiCl, where each R is an independently selected monovalent hydrocarbon group having from 1 to 18 carbon atoms.

8. The process of claim 7, where the hydridochlorosilane comprises chlorodimethylsilane of formula (CH₃)₂HSiCl.

9. The process of claim 1, where the process further comprises, before step 1), preparing (C) the heterogeneous metal catalyst by a process comprising depositing a Rhenium compound on the substrate via incipient wetness.

10. The process of claim 9, where the rhenium compound comprises Re₂(CO)₁₀.

11. The process of claim 1, where the support is selected from the group consisting of activated carbon, graphite, silicon carbide, alumina, ceria, silica, magnesium oxide, and calcium oxide.

12. The process of claim 11, where the support is selected from the group consisting of activated carbon and alumina.

13. The process of claim 1, where the vinyl-functional chlorosilane has formula (CH₂═CH—)R₍₃₋ₓ₎SiClₓ, where each R is an independently selected monovalent hydrocarbon group of 1 to 18 carbon atoms, and subscript x is 1 to 3.

14. The process of claim 13, where the vinyl-functional chlorosilane comprises vinyldimethylchlorosilane.

15. The process of claim 1, where (C) the heterogeneous metal catalyst further comprises an additional metal selected from the group consisting of silver (Ag), cobalt (Co), nickel (Ni), palladium (Pd), and iridium (Ir).

16. The process of claim 2, further comprising reducing (C) the heterogeneous metal catalyst before step 1).

17. The process of claim 3, further comprising reducing (C) the heterogeneous metal catalyst before step 1).

18. The process of claim 2, where the process further comprises an additional step, and the additional step is selected from the group consisting of:
2) cooling the reactor effluent after step 1), thereby condensing materials comprising the vinyl-functional chlorosilane and optionally unreacted (A) hydridochlorosilane;
3) gas/liquid separation after step 2);
4) recycling unreacted gaseous ethylene after step 2) or step 3);
5) recycling the unreacted hydridochlorosilane;
6) purifying the vinyl-functional chlorosilane; and
7) repeating step 1) using the gaseous ethylene from step 4) and/or the unreacted hydridochlorosilane from step 5); and
two or more of steps 2) to 7).

19. The process of claim 3, where the process further comprises an additional step, and the additional step is selected from the group consisting of:
2) cooling the reactor effluent after step 1), thereby condensing materials comprising the vinyl-functional chlorosilane and optionally unreacted (A) hydridochlorosilane;
3) gas/liquid separation after step 2);
4) recycling unreacted gaseous ethylene after step 2) or step 3);
5) recycling the unreacted hydridochlorosilane;
6) purifying the vinyl-functional chlorosilane; and
7) repeating step 1) using the gaseous ethylene from step 4) and/or the unreacted hydridochlorosilane from step 5); and
two or more of steps 2) to 7).

20. The process of claim 2, where the hydridochlorosilane has formula R₂HSiCl, where each R is an independently selected monovalent hydrocarbon group having from 1 to 18 carbon atoms.
